(19) United States
(12) Patent Application Publication
(10) Pub. No.: US 2014/0077750 A1
(43) Pub. Date: Mar. 20, 2014

(54) E Cubed Program

(71) Applicants: Daniel A. Hengel, Buffalo, WY (US); Robert M. Hengel, Aberdeen, SD (US)

(72) Inventors: Daniel A. Hengel, Buffalo, WY (US); Robert M. Hengel, Aberdeen, SD (US)

(21) Appl. No.: 13/470,313

(22) Filed: Jun. 8, 2012

(51) Int. Cl. H02J 7/14

(52) U.S. Cl. CPC H02J 7/1415
USPC 320/101

(57) ABSTRACT

The Program addresses 3 distinct methodologies: energy independence, environmental stewardship and sustainable economic growth. Vertical-axis wind turbines and solar panels will be strategically installed in parking lots and on roofs of commercial and residential structures to generate electricity for immediate and stored use. This program will encourage the conversion to electric/hybrid vehicle usage; utilize cleaner energy forms; reduce the need for fossil fuel consumption; reduce high voltage transmission lines; protect wildlife and environmental systems; improve quality of life.

This Program utilizes specific vertical-axis wind turbines (“VAWT”) and vehicle batteries to store electricity and to offset peak electric production cycles and peak demand surges. The vertical rotation and “fin” design will take advantage of the full 360° exposure to wind direction. There is no need to rotate or swivel the VAWT. The VAWT designed for the Program will have a kick-in wind speed as low as 0.5 mph, and an unlimited maximum wind speed with no vibration effects, as opposed to the vibration and “thumping” noise of propeller equipped wind turbines. There is an absence of rotating propeller (rotor) blades of the VAWTs designed for this Program.

The Program VAWT will be equipped with a variety of output capacities (0.5 kw or 500 watts up to 5-10 MW) utilizing either a solid shaft link to the generator (smaller models) or use a series of gears for the larger models. Inverters will be scaled to match the VAWT output design capacity and to compensate for variable wind speed.

The goal of the Program is to cover the extensive, cumulative, square miles of parking lots in major urban and suburban areas of the USA, in addition to residential and commercial rooftops, with the installations of solar panels and VAWTs. The solar arrays and VAWTs will be installed above parking lots for shopping malls, office complexes and large retail “box stores” which will generate output. Utilizing this output, we create links for electric, and/or hybrid, cars and light-duty trucks to be plugged-in while people are shopping, or working, to recharge the vehicles batteries, store electricity in the vehicle's batteries and protect the vehicle owner's investment by shading the vehicles (protecting paint, dashboards, upholstery, tires, etc).

The co-applicants will establish training programs at community colleges and trade schools to equip people to design, build, install, and maintain the millions of VAWT generators and solar panels needed to make this Program a success. The co-applicants will also establish partnerships with manufacturing firms for production of the VAWT generators and solar panels. Jobs will be created, and trained people will be needed, to install systems, others will be needed to maintain systems, others will be needed to continue the research for improvements in solar panel efficiency, and VAWTs output efficiency.

Funding for the Program may be derived from the government enacted TARP program and funneled through the various executive branch departments (DoAgriculture for funding assistance to farm/ranch/rural residences; DoCommerce for funding assistance for program installations at businesses; DoDefense for program installations on military bases; DoEducation for training/re-training assistance; DoEnergy for funding assistance for research, design, and production (RD&P) of program components; DoHealth and Human Services for funding assistance for air quality monitoring and ER visits; DoHousing and Urban Development for funding assistance for program development in urban/suburban areas; DoLabor for funding assistance to communities/states to assist with licensing new workers for program implementation; DoState for program implementation in foreign countries; and other agencies/commissions) to assist with program development and implementation.

### BACKGROUND OF THE INVENTION

The original concepts for this Program were e-mailed to Sen. Tim Johnson, (D) SD, in April, 2010, and hand delivered to Sen. Johnson's office in Aberdeen S.Dak. in May 2010. In addition, the paper was e-mailed to the White House, the DNC, and to the Governor of California in May and June of 2010. The Governor's Office replied with an e-mail thanking the creative and innovative approach, and the willingness to participate in solving pressing issues in CA. However, no further communication was received from the Governor of California by the co-applicants.

The interrelationship of energy, environment and economics is most apparent from the standpoint of renewable sources of electricity (e.g. wind and solar). By generating electricity in the areas as described above, the need for thousands of miles of high voltage transmission lines will be reduced and the environmental impacts from building 500 and or 760 kV high voltage transmission lines across vast reaches of the western USA will be minimized, if not avoided completely.

A combination of solar and wind generation VAWTs has the potential to generate more kilowatts of electricity than used by the average home, generating revenue for the homeowner/landlord, and becoming a source for surplus electricity which then can be integrated into the local electric grid. Generating electricity in the demand areas will greatly reduce the need to generate electricity hundreds, or thousands, of miles away and then build large, expensive transmission lines to move the electricity from remote generation sites to the higher demand areas. Consequential benefits of the Program could include a greater demand for plug-in and hybrid vehicles. Thus, the Program was invented by the co-applicants.

### BRIEF SUMMARY OF THE INVENTION

Specific VAWTs will be manufactured and installed along with solar panels over parking lots for shopping malls, office complexes and large retail box stores and on residential rooftops to generate output for recharging electric/hybrid vehicles, to store electricity and to offset peak electric production cycles and peak demand surges. This Program will lower the demand for electricity generation from coal-fired power plants. The Program will decrease the need for high-voltage transmission lines criss-crossing the western USA.

There will be many residual benefits of this Program, including but not limited to:
Air quality will be greatly improved due to replacing or phasing out a large number of internal combustion engines in densely populated urban centers;
Improved health conditions in urban areas;
Reduced trips to hospital ERs due to improved air quality;
Businesses will be encouraged to install solar panels and VAWTs over parking lots to demonstrate environmental stewardship, and promote “green friendly” shopping experiences for their customers;
More customers will patronize business with available plug-in stations;
Pathway established to reduce greenhouse gas (GHG) emissions locally and globally; and
Move fossil fuels from a primary energy source to an energy source.

### BRIEF DESCRIPTION OF THE DRAWINGS

The attached figures illustrate the VAWT design for the Program.

FIG. 1 illustrates a Model 6200 VAWT according to one embodiment of the present invention.

FIG. 2 illustrates another VAWT according to one embodiment of the present invention.

FIG. 3 illustrates a Model 1800 VAWT according to one embodiment of the present invention.

FIG. 4 illustrates a Model 3600 VAWT according to one embodiment of the present invention.

FIG. 5 illustrates a shopping center building and associated parking lot including a plurality of VAWTs placed in the lot according to an embodiment of the present invention.

FIG. 6 illustrates a flat roof commercial building with 3 VAWTs of varying size placed on the roof according to an embodiment of the present invention.

FIG. 7 illustrates a flat roof commercial building with 3 medium VAWTs of same size placed on roof according to an embodiment of the present invention.

FIG. 8 illustrates a flat roof commercial building with 3 small VAWTs of same size placed on roof according to an embodiment of the present invention.

FIG. 9 illustrates an A-frame roof residential structure with 1 large VAWT on the peak of the roof according to an embodiment of the present invention.

FIG. 10 illustrates an A-frame roof residential structure with 1 small VAWT on the peak of the roof according to an embodiment of the present invention.

FIG. 11 illustrates an A-frame roof residential structure with 1 medium VAWT on the slant of the roof according to an embodiment of the present invention.

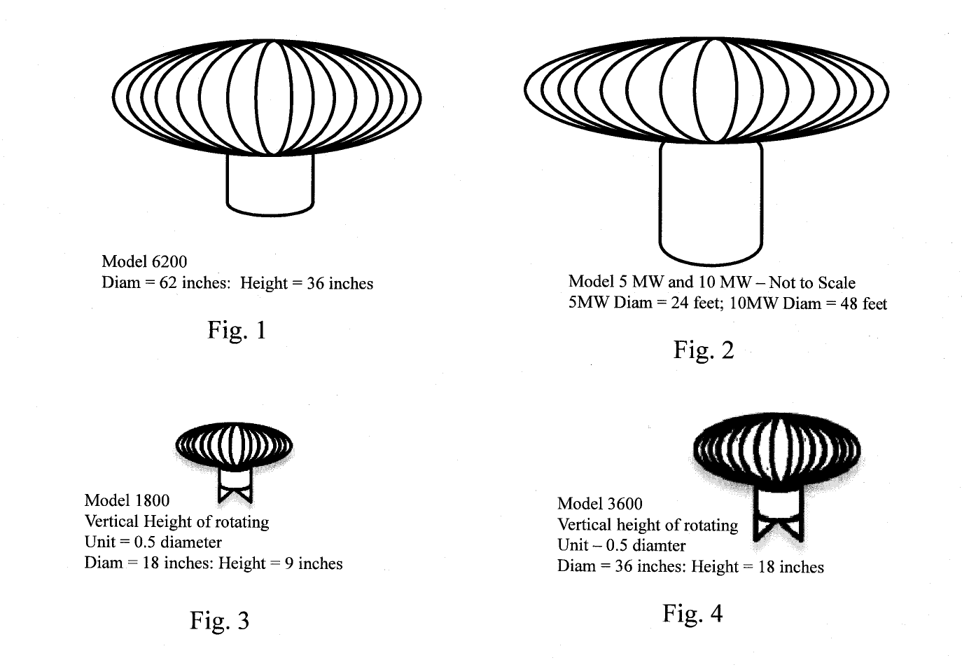

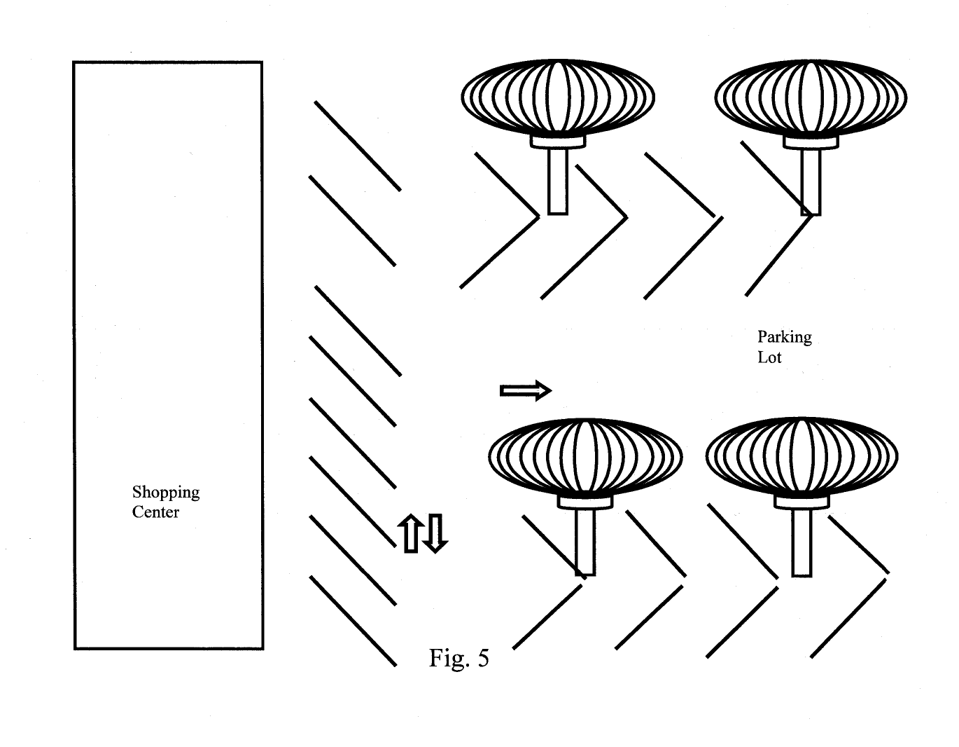

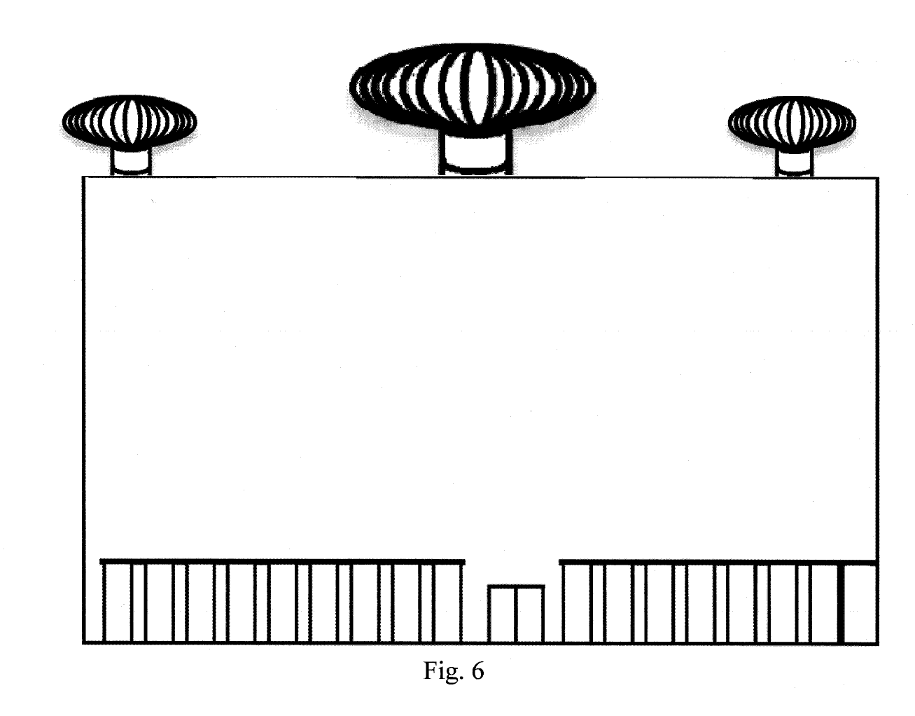

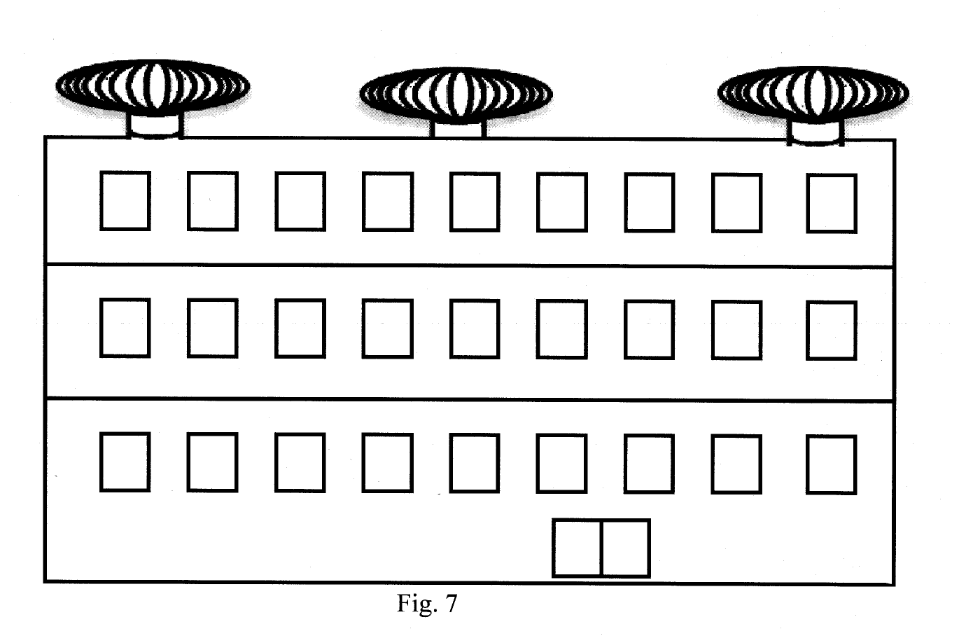

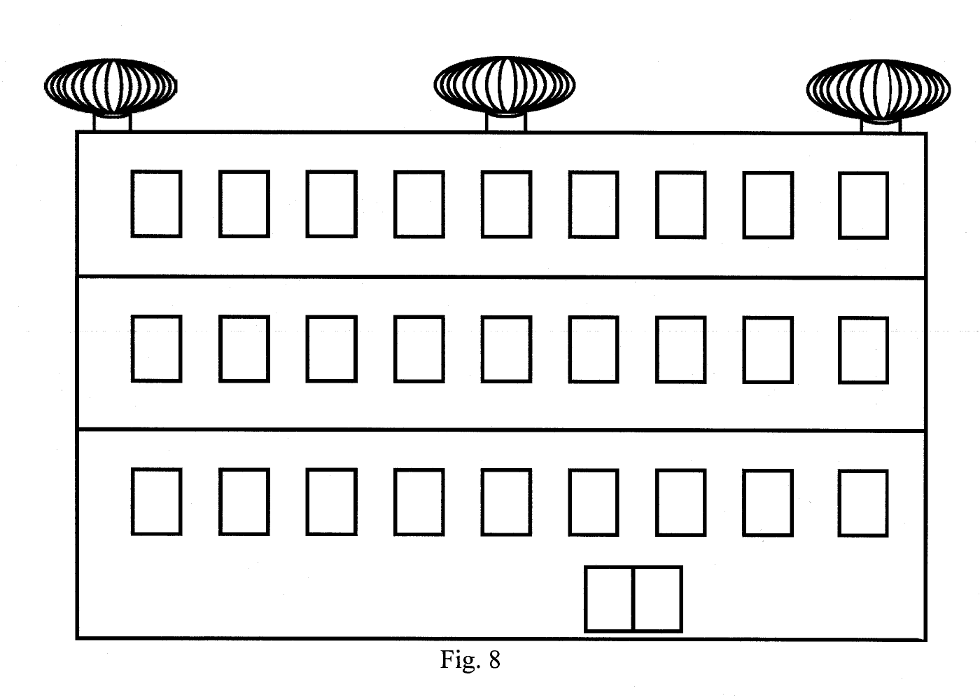

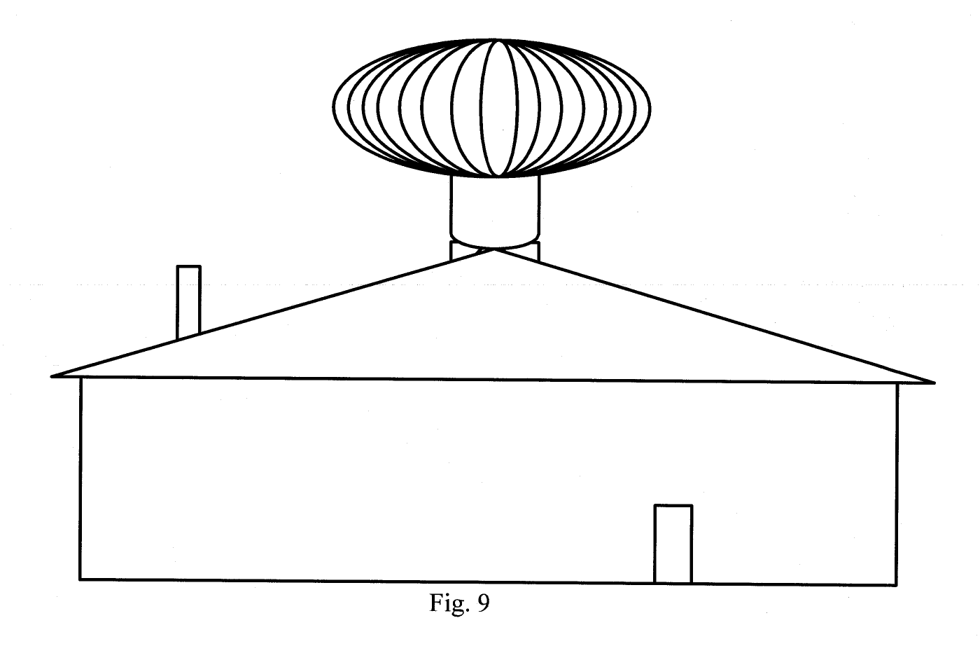

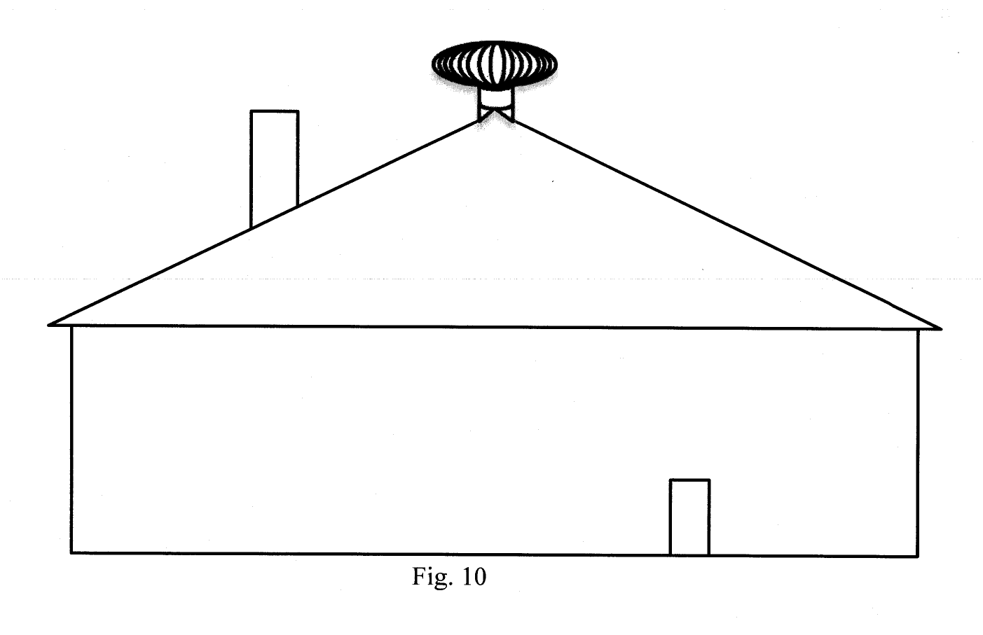

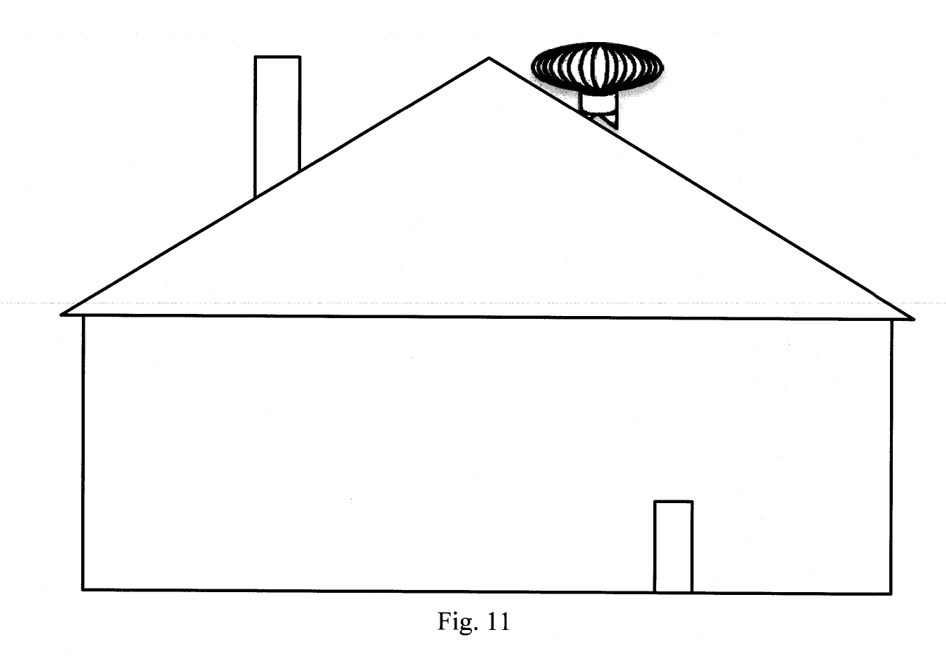

### DETAILED DESCRIPTION OF THE INVENTION

This Program utilizes four different specific vertical-axis wind turbines, as shown in A-1. The VAWTs will be manufactured by select companies with expertise in the production of such products. The material used in producing the VAWTs will be of some form of metal, or metal-like material, that is durable and provides variable weather resistance. The installation onto a structure is of a permanent, non-mobile nature. These VAWTs and solar panels will be used in conjunction with vehicle batteries to store electricity, to recharge electric or hybrid vehicles and to offset peak electric production cycles and peak demand surges.

The solar arrays and VAWTs will be built and installed above parking lots for shopping malls, office complexes, large retail box stores and residential structures, as shown in A-2-A-8. The co-applicants will establish relationships with land owners and real estate owners in targeted areas for approval of the installation of the VAWTs. The design of the VAWTs will not require changes in local zoning rules and ordnances or necessitate cumbersome regulatory review due to the lack of impacts to wildlife resources, lack of visual intrusion, and lack of high vertical structures to support the wind turbines due to the lack of rotor blades or a propeller to initiate and sustain movement of the generator.

The vertical rotation and “fin” design will take advantage of the full 360° exposure to wind direction. There is no need to rotate or swivel the VAWT. The VAWT designed for the Program will have a kick-in wind speed as low as 0.5 mph, and an unlimited maximum wind speed with no vibration effects, as opposed to the vibration and “thumping” noise of propeller equipped wind turbines. There is an absence of rotating propeller (rotor) blades of the VAWTs designed for this Program.

The VAWTs are air-flow operated and will generate output. Links are created for electric, and/or hybrid, cars and light-duty trucks to be plugged-in while people are shopping, or working, to recharge the vehicles batteries, store electricity in the vehicle's batteries and protect the vehicle owner's investment by shading the vehicles (protecting paint, dashboards, upholstery, tires, etc). The output generated from the VAWTs will be utilized to provide such benefits.

The Program VAWT will be equipped with a variety of output capacities (0.5 kw or 500 watts up to 5-10 MW) utilizing either a solid shaft link to the generator (smaller models) or use a series of gears for the larger models. Inverters will be scaled to match the VAWT output design capacity and to compensate for variable wind speed.

The co-applicants will establish training programs at community colleges and trade schools to equip people to design, build, install, and maintain the millions of VAWT generators and solar panels needed to make this Program a success. The co-applicants will also establish partnerships with manufacturing firms for production of the VAWT generators and solar panels. Jobs will be created, and trained people will be needed, to install systems, others will be needed to maintain systems, others will be needed to continue the research for improvements in solar panel efficiency, and VAWTs output efficiency.

Funding for the Program may be derived from the government enacted TARP program and funneled through the various executive branch departments (DoAgriculture for funding assistance to farm/ranch/rural residences; DoCommerce for funding assistance for program installations at businesses; DoDefense for program installations on military bases; DoEducation for training/re-training assistance; DoEnergy for funding assistance for research, design, and production (RD&P) of program components; DoHealth and Human Services for funding assistance for air quality monitoring and ER visits; DoHousing and Urban Development for funding assistance for program development in urban/suburban areas; DoLabor for funding assistance to communities/states to assist with licensing new workers for program implementation; DoState for program implementation in foreign countries; and other agencies/commissions) to assist with program development and implementation. Private equity may also contribute to initial funding of this Program.

The interrelationship of energy, environment and economics is most apparent from the standpoint of renewable sources of electricity (e.g. wind and solar). By generating electricity in the areas as described above, the need for thousands of miles of high voltage transmission lines will be reduced and the environmental impacts from building 500 and or 760 kV high voltage transmission lines across vast reaches of the western USA will be minimized, if not avoided completely.

A combination of solar and wind generation VAWTs has the potential to generate more kilowatts of electricity than used by the average home, generating revenue for the homeowner/landlord, and becoming a source for surplus electricity which then can be integrated into the local electric grid. Generating electricity in the demand areas will greatly reduce the need to generate electricity hundreds, or thousands, of miles away and then build large, expensive transmission lines to move the electricity from remote generation sites to the higher demand areas. Consequential benefits of the Program could include a greater demand for plug-in and hybrid vehicles. This Program will lower the demand for electricity generation from coal-fired power plants. The Program will decrease the need for high-voltage transmission lines criss-crossing the western USA.

Some of the benefits offered by this Program are: (1) air quality will be greatly improved due to replacing or phasing out a large number of internal combustion engines in densely populated urban centers; (2) improved health conditions in urban areas; (3) reduced trips to hospital ERs due to improved air quality; (3) businesses will be encouraged to install solar panels and VAWTs over parking lots to demonstrate environmental stewardship, and promote “green friendly” shopping experiences for their customers; (4) more customers will patronize business with available plug-in stations; (5) pathway established to reduce greenhouse gas (GHG) emissions locally and globally; and (6) move fossil fuels from a primary energy source to an energy source.

This Program will have other positive consequences, especially in under-developed parts of the world. This Program could reverse immigration trends in southwestern USA by creating jobs in Mexico, Central and South America to build, install, and maintain solar and wind systems for homes and parking lots in our neighboring countries. It may also improve the standard of living in Africa and Asia through the installation of solar and VAWTs in villages to create locally generated electricity to power fans and lights. There will not be a need to build transmission lines to bring electricity to villages in third-world nations. People in less developed countries will now have access to cooling fans and refrigeration where none previously existed. This Program may also reduce the demand to burn wood/manure/straw to cook and heat homes during the coldest months in the equatorial regions. This reduces GHG emissions.

There is no process that matches the characteristics of the Program. No such process has been or is being utilized today. The VAWTs of this Program differ from horizontal and rotor turbines, as described above. The derived benefits are not being captured by any single process. This Program is unlike any other in that it can improve the quality of living in the US as well as for people in under-developed areas of the planet by coordinating a solar/wind energy program that encourages cleaner operating vehicles, improves air quality and quality of life and captures and stores electricity for various purposes.

Claim to the invention:

1. The co-applicants are the inventors of this unique Program and underlying concepts. The VAWTs specific to this Program are unique to the usage and derived benefits and have been created by the co-applicants. The co-applicants wish to obtain a utility patent for this Program for protection of their intellectual property invention of a new and useful process that permits the co-applicants to exclude others from making, using, or selling the invention for a period of up to twenty years from the date of patent application filing, subject to the payment of maintenance fees.
